(19) United States
(12) Patent Application Publication
(10) Pub. No.: US 2005/0177346 A1
(43) Pub. Date: Aug. 11, 2005

(54) Process parameter monitoring system and method of use

(76) Inventor: Matthew R. Williams, Lansdale, PA (US)

Correspondence Address: RATNERPRESTIA, P O BOX 980, VALLEY FORGE, PA, 19482-0980, US

(21) Appl. No.: 10/776,787

(22) Filed: Feb. 11, 2004

(51) Int. Cl. G06F 11/00

(52) U.S. Cl. 702/188

(57) ABSTRACT

A system for monitoring a process parameter includes a computer configured to receive data corresponding to the process parameter. The system also includes at least one sensor configured to measure the process parameter. The at least one sensor is coupled for communication of data corresponding to the process parameter to the computer. The system also includes an interface configured for communicating data corresponding to the process parameter from the at least one sensor. The interface is configured to provide data to the computer via a portable computer as a secondary measurement of the process parameter.

### FIELD OF THE INVENTION

This invention relates to systems for monitoring process parameters, and more particularly, to systems for verifying a primary measurement of a process parameter with a secondary measurement.

### BACKGROUND OF THE INVENTION

In a variety of industries, process parameters are measured and tracked to determine the status of certain process conditions. Such process parameters include temperature, flow, pressure, voltage, current, and a variety of other parameters.

In some industries (e.g., where the accuracy of the measurement of the parameter is critical) it is desirable to verify a measurement of a process parameter by obtaining a back-up measurement. For example, in the blood storage industry, a blood storage environment is desirably kept within a predetermined temperature range. A monitoring system measures the temperature and transmits the measured temperature to a data collection system.

In order to obtain back-up data related to the measured temperature, an operator typically observes a process measurement device (e.g., a thermometer) at the process site (e.g., the blood storage environment). The observed temperature is then manually recorded onto a log sheet. The log sheet is then stored, and ultimately the data on the log sheet is intended to be manually integrated into an electronic record; however, several opportunities for error are introduced in this process. For example, potential error exists when the operator observes the measurement of the process parameter. Additional potential error is introduced during the manual recording of the observed measurement onto the log sheet. Further, potential error is introduced in storing the log sheet (e.g., the log sheet may become lost, damaged, or destroyed). Further still, potential error is introduced during the manual integration of the data from the log sheet into an electronic record. In industries where verification of process parameter measurements is critical (and where such verification may even be required, for example, by government regulation), such opportunities for error are very undesirable.

Therefore, it would be desirable to provide a process parameter verification system that overcomes one or more of the above-recited deficiencies.

### SUMMARY OF THE INVENTION

According to an exemplary embodiment of the present invention, a system for monitoring a process parameter is provided. The system includes a computer configured to receive data corresponding to the process parameter. The system also includes at least one sensor configured to measure the process parameter. The at least one sensor is coupled for communication of data corresponding to the process parameter to the computer. The system also includes an interface configured for communicating data corresponding to the process parameter from the at least one sensor. The interface is configured to provide data to the computer via a portable computer as a secondary measurement of the process parameter.

According to another exemplary embodiment of the present invention, another system for monitoring a process parameter is provided. The system includes a computer configured to receive data corresponding to the process parameter. The system also includes a primary sensor configured to measure the process parameter. The primary sensor is coupled for communication of data corresponding to the process parameter to the computer. The system also includes a secondary sensor configured to measure the process parameter as a secondary measurement of the process parameter. Further, the system includes an interface configured to receive secondary data corresponding to the process parameter from the secondary sensor. Further still, the system includes a portable computer configured to retrieve secondary data corresponding to the process parameter from the interface. The portable computer is configured to transmit the secondary data to the computer to verify the measurement of the primary sensor.

According to yet another exemplary embodiment of the present invention, a method of verifying a measurement of a process parameter is provided. The method includes measuring a process parameter with at least one sensor, and transmitting data corresponding to the measured process parameter to a computer via a coupling between the at least one sensor and the computer. The method also includes retrieving secondary data corresponding to the measured process parameter from the at least one sensor using an interface, and transmitting the secondary data to the is computer via a portable computer.

### BRIEF DESCRIPTION OF THE DRAWINGS

Exemplary embodiments of the invention will be described with reference to the drawings, of which:

FIG. 1 is a block diagram illustrating a system for monitoring a process parameter in accordance with an exemplary embodiment of the present invention;

FIG. 2 is a block diagram illustrating a system for monitoring a temperature of a blood storage environment in accordance with another exemplary embodiment of the present invention;

FIG. 3 is a flow diagram illustrating a method of verifying a process parameter in accordance with an exemplary embodiment of the present invention; and

FIG. 4 is another flow diagram illustrating another method of verifying a process parameter in accordance with an exemplary embodiment of the present invention.

### DETAILED DESCRIPTION OF THE INVENTION

Preferred features of embodiments of this invention will now be described with reference to the figures. It will be appreciated that the spirit and scope of the invention is not limited to the embodiments selected for illustration. It is contemplated that any of the configurations described hereafter can be modified within the scope of this invention.

Referring to the Figures generally, a system for monitoring a process parameter is provided. The system includes a computer 100 configured to receive data corresponding to the process parameter. The system also includes at least one sensor 102 (and/or 106) configured to measure the process parameter. The at least one sensor 102 is coupled for communication of data corresponding to the process parameter to the computer 100. The system also includes an interface 108 configured for communicating data corresponding to the process parameter from the at least one sensor 106. The interface 108 is configured to provide data to the computer 100 via a portable computer 112 as a secondary measurement of the process parameter.

According to another exemplary embodiment of the present invention, another system for monitoring a process parameter includes a computer 100 configured to receive data corresponding to the process parameter. The system also includes a primary sensor 102 configured to measure the process parameter. The primary sensor 102 is coupled for communication of data corresponding to the process parameter to the computer 100. The system also includes a secondary sensor 106 configured to measure the process parameter as a secondary measurement of the process parameter. Further, the system includes an interface 108 configured to receive secondary data corresponding to the process parameter from the secondary sensor 106. Further still, the system includes a portable computer 112 configured to retrieve secondary data corresponding to the process parameter from the interface 108. The portable computer 112 is configured to transmit the secondary data to the computer 100 to verify the measurement of the primary sensor 102.

According to yet another exemplary embodiment of the present invention, a method of verifying a measurement of a process parameter includes measuring a process parameter with at least one sensor 102 (and/or 106), and transmitting data corresponding to the measured process parameter to a computer 100 via a coupling 104 between the at least one sensor 102 and the computer 100. The method also includes retrieving secondary data corresponding to the measured process parameter from the at least one sensor 106 using an interface 108, and transmitting the secondary data to the computer 100 via a portable computer 112.

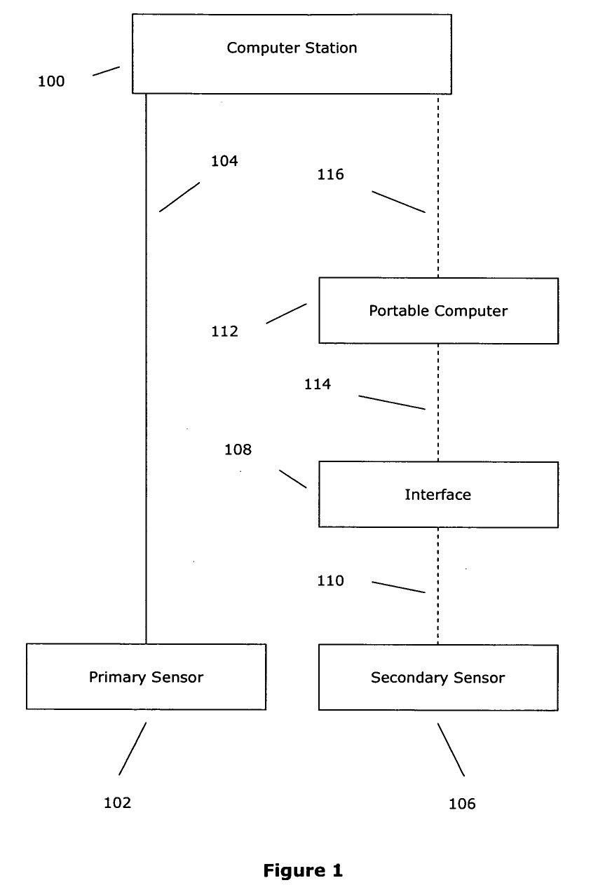

FIG. 1 is a block diagram illustrating an exemplary system for monitoring a process parameter. Primary sensor 102 measures a process parameter, and data corresponding to the measured process parameter is transmitted from primary sensor 102 to computer station 100 via direct connection 104.

The process parameter measured by primary sensor 102 may be any of a number of process parameters. For example, the process parameter may relate to temperature, pressure, electrical voltage, electrical current, electrical power, electrical resistance, speed (e.g., revolutions per minute of a motor), viscosity, etc. Thus, primary sensor may include a thermocouple, thermometer, RTD, pressure sensor, voltmeter, ammeter, wattmeter, ohmmeter, tachometer, rheometer, etc.

Direct connection 104 may be, for example, a hard-wired voltage connection (e.g., 0-5 V DC signal, 0-10 V DC signal), a hard-wired current connection (e.g., 0-20 mA signal, 4-20 mA signal), an RS-232 connection, an RS-485 connection, a fiber optic connection, a radio frequency connection, an infrared connection, etc.

The process parameter is also measured using secondary sensor 106. Data corresponding to the measured process parameter is transmitted from secondary sensor 106 to interface 108 via connection 110. Further, the data is transmitted from interface 108 to portable computer 112 via connection 114. Further still, the data is transmitted from portable computer 112 to computer station 100 via connection 116.

Thus, through the data provided by secondary sensor 106 and ultimately received by computer station 100, a secondary measurement of the process parameter is provided for verifying the primary measurement of the process parameter (i.e., the measurement transmitted from primary sensor 102 to computer station 100).

Secondary sensor 106 may be local with respect to the process parameter (e.g., in contact with the process parameter), or may be remote with respect to the process parameter (e.g., sensing the status of the process parameter remotely).

Connection 110 between secondary sensor 106 and interface 108 may be any of a number of connections, for example, a direct connection, an infrared connection, and a wireless connection (e.g., a radio frequency connection). Further, connection 110 may be a fixed connection or a temporary connection that is established when data is to be retrieved from secondary sensor 106. Connection 110 may provide physical separation (e.g., for safety and/or convenience) between the operator (e.g., who may be holding a portable computer for coupling to the interface) and secondary sensor 106. Additionally, in certain exemplary embodiments of the present invention, secondary sensor 106 and interface 108 may be integrated into a single system. Secondary sensor 106 may be fixed in place with respect to the process parameter being measured, or secondary sensor 106 may be portable. In an embodiment where secondary sensor 106 is portable, and where interface 108 is integrated with secondary sensor 106, interface 108 is also portable.

Likewise, connection 114 between interface 108 and portable computer 112 may be any of a number of connections, for example, a direct connection, an infrared connection, and a wireless connection. Further, connection 114 may be a fixed connection or a temporary connection. Further still, interface 108 and portable computer 112 may be integrated into a single system. In such an integrated embodiment, interface 108 is also portable.

Likewise, connection 116 between portable computer 112 and computer station 100 may be any of a number of connections, for example, a direct connection, an infrared connection, and a wireless connection.

Secondary sensor 106 may measure the process parameter on a continuous basis or periodically at a predetermined interval. Alternatively, secondary sensor 106 may measure the process parameter upon the occurrence of a predetermined event. For example, such a predetermined event may be an alarm occurring with respect to the process parameter at computer station 100. In such an embodiment, the process parameter measurement resulting in the alarm (e.g., from primary sensor 102) is verified using a measurement provided by secondary sensor 106.

Although primary sensor 102 and secondary sensor 106 are illustrated in FIG. 1 as distinct from one another, the process parameter measurements (and the corresponding signals transmitted therefrom) may be provided by a single sensor. Thus, the single sensor may be configured to transmit data corresponding to the measured process parameter to computer station 100 as a primary measurement, and to interface 108 as a secondary measurement (and subsequently to portable computer 112 and computer station 100). In such an embodiment, connection 104 between the single sensor and computer station 100 would be a primary connection, and the connection between the single sensor and interface 108 would be a secondary connection.

Therefore, an exemplary application of the configuration illustrated in FIG. 1 is as follows: Computer station 100 is provided for receiving signals from sensors that measure process parameters associated with a process. For example, computer station 100 may be included in a control room of a manufacturing or storage facility. One or more operators (e.g., control room operators) may monitor computer station 100. One of the signals received by computer station is from primary sensor 102, and this signal includes data corresponding to a process parameter measured by primary sensor 102. For example, primary sensor 102 may continuously measure the process parameter and transmit data to computer station 100 related to this measurement. Alternatively, primary sensor 102 may measure the process parameter at a predetermined interval and transmit data corresponding to the measured process parameter to computer station 100 at the predetermined interval.

Based on a signal provided by primary sensor 102, an alarm issues at computer station 100. For example, the alarm may indicate that the measured process parameter is outside of an acceptable range. An individual (e.g., an operator) desires to verify the measurement provided by primary sensor 102. The operator establishes a communication path between portable computer 112 and interface 108, and retrieves data corresponding to a secondary measurement of the process parameter through interface 108 (e.g., the secondary measurement provided by secondary sensor 106). The operator then establishes a communication path between portable computer 112 and computer station 100, and transmits the data corresponding to the secondary measurement of the process parameter to computer station 100. This data may then be integrated into an electronic record in computer station 100. Thus, the measurement of the process parameter obtained by primary sensor 102 is verified. Through this verification, the integrity of the entire primary measurement system (e.g., primary sensor 102 and connection 104) is checked.

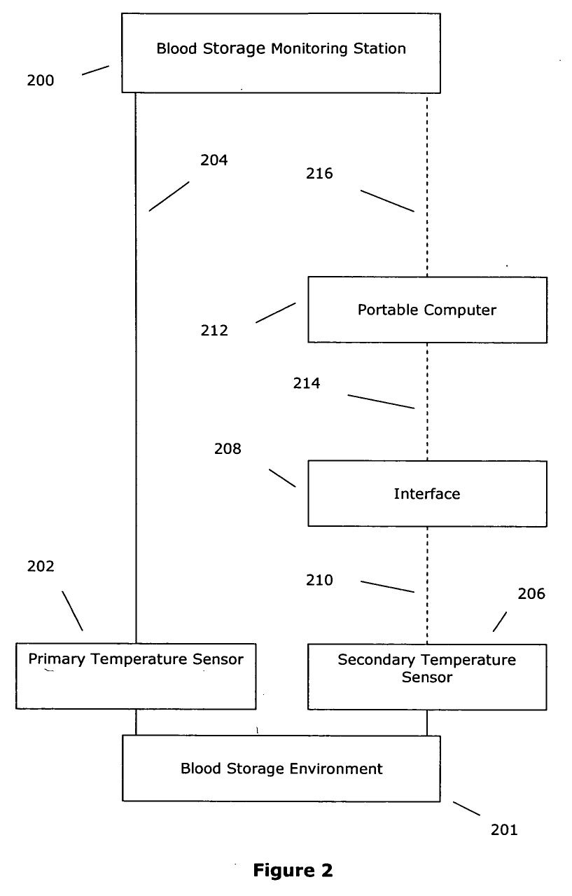

FIG. 2 is a block diagram illustrating an exemplary system for monitoring a blood storage environment temperature. Primary temperature sensor 202 measures the temperature in blood storage environment 201 (e.g., a blood refrigerator, a blood freezer, a blood warehouse, etc.), and data corresponding to the measured temperature is transmitted from primary temperature sensor 202 to blood storage monitoring station 200 via direct connection 204. For example, primary temperature sensor 202 may include a thermometer, thermocouple, or any of a number of temperature sensing devices. Primary temperature sensor 202 may include an output mechanism for transmitting the data corresponding to the measured blood storage environment temperature to blood storage monitoring station 200 (e.g., a centralized temperature monitoring system). Alternatively, primary temperature sensor 202 may be coupled to such an output mechanism.

As with direct connection 104 described above with respect to FIG. 1, direct connection 204 may be any of a number of direct connections. For example, direct connection 204 may be a hard-wired voltage connection (e.g., 0-5 V DC signal, 0-10 V DC signal), a hard-wired current connection (e.g., 0-20 mA signal, 4-20 mA signal), an RS-232 connection, an RS-485 connection, a fiber optic connection, a radio frequency connection, etc.

The temperature in blood storage environment 201 is also measured using secondary temperature sensor 206. Data corresponding to the measured temperature is transmitted from secondary temperature sensor 206 to interface 208 via connection 210. Further, the data is transmitted from interface 208 to portable computer 212 via connection 214. Further still, the data is transmitted from portable computer 212 to blood storage monitoring station 200 via connection 216.

Thus, through the data transmitted from secondary temperature sensor 206 and ultimately received by blood storage monitoring station 200, a secondary measurement of the temperature of blood storage environment 201 is provided for verifying the temperature data transmitted from primary sensor 202 to blood storage monitoring station 200.

Secondary temperature sensor 206 may be local with respect to blood storage environment 201, or may be remote with respect to blood storage environment 201.

Connection 210 between secondary temperature sensor 206 and interface 208 may be any of a number of connections, for example, a direct connection, an infrared connection, and a wireless connection (e.g., a radio frequency connection. Alternatively, secondary temperature sensor 206 and interface 208 may be integrated into a single system.

Likewise, connection 214 between interface 208 and portable computer 212 may be any of a number of connections, for example, a direct connection, an infrared connection, and a wireless connection. Alternatively, interface 208 and portable computer 212 may be integrated into a single system.

Likewise, connection 216 between portable computer 212 and blood storage monitoring station 200 may be any of a number of connections, for example, a direct connection, an infrared connection, and a wireless connection.

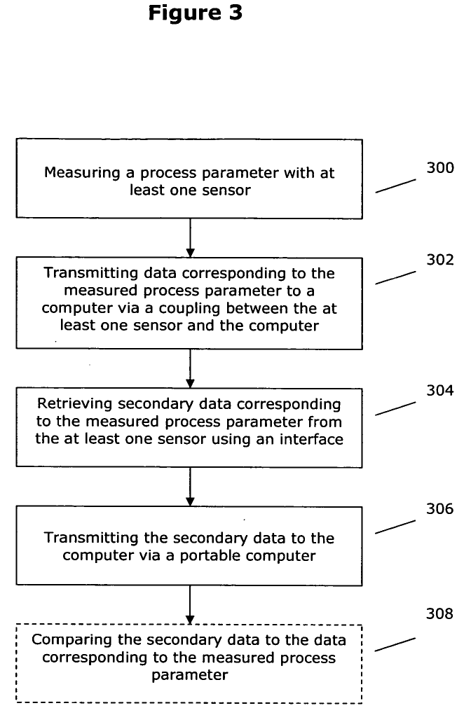

FIG. 3 is a flow diagram illustrating a method of verifying a measurement of a process parameter in accordance with an exemplary embodiment of the present invention. At step 300, a process parameter is measured with at least one sensor. At step 302, data corresponding to the measured process parameter is transmitted to a computer via a coupling between the at least one sensor and the computer. At step 304, secondary data corresponding to the measured process parameter is retrieved from the at least one sensor using an interface. At step 306, the secondary data is transmitted to the computer via a portable computer. At optional step 308, the secondary data is compared to the data corresponding to the measured process parameter to verify the accuracy of the data corresponding to the measured process parameter.

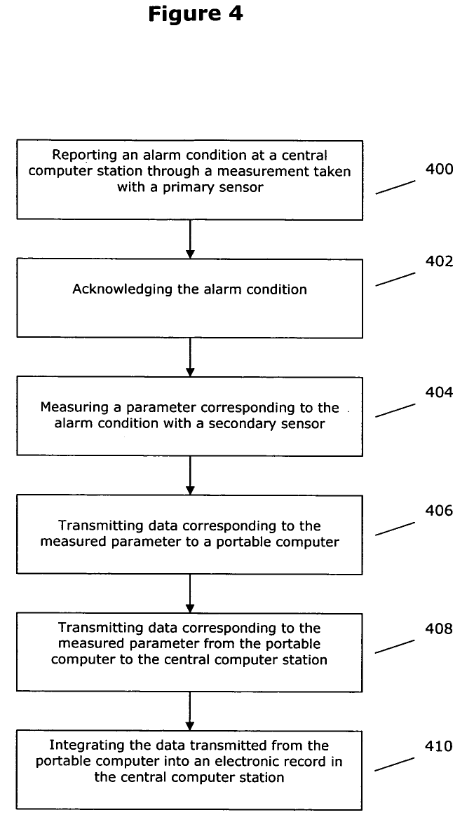

FIG. 4 is a flow diagram illustrating another method of verifying a measurement of a process parameter. At step 400, an alarm condition is reported at a central computer station through a measurement taken with a primary sensor. At step 402, the alarm condition is acknowledged. For example, in order to acknowledge the alarm condition, an individual (e.g., an operator) may verify his/her identity. Such identification verification may be accomplished by entering a username and a password at the central computer station. At step 404, a process parameter corresponding to the alarm condition is measured with a secondary sensor. At step 406, data corresponding to the measured process parameter is transmitted to a portable computer. For example, an operator may establish a communication path between the portable computer and the secondary sensor, for example, through an interface. While establishing the communication path, the operator may be able to observe a local visual indication of the measured parameter. In the case of a temperature sensor that measures the parameter, the local visual indication may take the form of a digital readout. At step 408, data corresponding to the measured parameter is transmitted from the portable computer to the central computer station. At step 410, the data transmitted from the portable computer is integrated into an electronic is record in the central computer station.

Through the various exemplary embodiments of the present invention described herein, the secondary data transmitted primarily relates to a secondary measurement of the process parameter; however, additional data may be provided with this data transmission. For example, the time that the measurement was taken or the time of the data transmission may be included in the data stream. Additional information included with the data stream may also include the serial number of the sensor, other identifying information related to the sensor, and identification data related to the equipment or system being monitored (e.g., the serial number of a motor whose speed is being monitored).

In addition to retrieving data corresponding to the secondary measurement of the process parameter, additional actions may be performed by an operator while the connection between the portable computer and the interface (and/or secondary sensor) is established. For example, setpoints of the sensor (e.g., maximum and minimum process threshold limits) may be adjusted using the portable computer. Such setpoints may be used to redefine the thresholds for alarming related to the measured process parameter. Further, the frequency of the secondary measurement may be adjusted using the portable computer.

Although the present invention has primarily been described by reference to a single process parameter measurement being provided by the secondary sensor, it is not limited thereto. Multiple process parameter measurements may be provided by the secondary sensor at one time, for example, in a batch. Such a data batch may be organized in a number of ways, for example, by time of the measurement, or by identification of a condition (e.g., an alarm) that caused the measurement.

The interface between the secondary sensor and the portable computer may be configured to provide a digital signal to the portable computer. Alternatively, the portable computer may include an analog to digital converter configured for receiving analog data from the interface, where the portable computer converts the analog data to digital data for transmission to the computer station.

Examples of the portable computer described in connection with the present invention include a PDA, a Pocket PC, a laptop or notebook computer, and any of various other portable computer devices that include memory to store the data related to the measured process parameter.

As described above, various elements provided in connection with the present invention (e.g, the secondary sensor, the interface, and the portable computer) may be integrated into one or more devices. For example, the secondary sensor and the interface may be integrated into a single device. Further, the interface and portable computer may be integrated into a single device. Further still, the secondary sensor, the interface, and the portable computer may be integrated into a single portable device.

Although the invention is illustrated and described herein with reference to specific embodiments, the invention is not intended to be limited to the details shown. Rather, various modifications may be made in the details within the scope and range of equivalents of the claims and without departing from the invention.

1. A system for monitoring a process parameter, said system comprising:
a computer configured to receive data corresponding to a process parameter;
at least one sensor configured to measure the process parameter, said at least one sensor being coupled for communication of data corresponding to the process parameter to said computer; and
an interface configured for communicating data corresponding to the process parameter from said at least one sensor, said interface being configured to provide data to said computer via a portable computer as a secondary measurement of the process parameter.

2. The system of claim 1 wherein said at least one sensor includes a primary sensor coupled for communication of data corresponding to the process parameter to said computer, and a secondary sensor configured to provide data to said portable computer.

3. The system of claim 2 wherein said secondary sensor is a portable sensor, and said interface is a portable interface, said secondary sensor being configured for portable use with said interface and said portable computer.

4. The system of claim 1 additionally comprising the portable computer.

5. The system of claim 4 wherein the portable computer includes an analog to digital converter configured for receiving analog data from said interface and converting the analog data to digital data for transmission to said computer.

6. The system of claim 1 wherein said computer is configured to provide an alarm when data communicated from said at least one sensor to said computer indicates that the process parameter is outside of a predetermined range.

7. The system of claim 1 wherein said interface is configured to communicate with said at least one sensor through at least one of a hard-wired, infra-red and wireless connection.

8. The system of claim 1 wherein said interface is a portable interface configured for portable use with the portable computer.

9. The system of claim 1 wherein said interface is configured to communicate identification data corresponding to said at least one sensor to the portable computer along with data corresponding to the process parameter.

10. The system of claim 1 wherein the process parameter corresponds to a temperature of a blood storage environment, and said at least one sensor includes a temperature sensor configured to measure the temperature of the blood storage environment.

11. The system of claim 10 wherein the at least one sensor includes a primary temperature sensor coupled for communication of data corresponding to the temperature of the blood storage environment to said computer, and a secondary temperature sensor configured to provide data to the portable computer.

12. A system for monitoring a process parameter, said system comprising:
a computer configured to receive data corresponding to a process parameter;
a primary sensor configured to measure the process parameter, said primary sensor being coupled for communication of data corresponding to the process parameter to said computer;
a secondary sensor configured to measure the process parameter as a secondary measurement of the process parameter;
an interface configured to receive secondary data corresponding to the process parameter from said secondary sensor; and
a portable computer configured to retrieve secondary data corresponding to the process parameter from said interface, said portable computer being configured to transmit the secondary data to the computer to verify the measurement of said primary sensor.

13. The system of claim 12 wherein said secondary sensor is a portable sensor, and said interface is a portable interface, said secondary sensor being configured for portable use with said interface and said portable computer.

14. The system of claim 12 wherein the portable computer includes an analog to digital converter configured for receiving analog data from said interface and converting the analog data to digital data for transmission to said computer.

15. The system of claim 12 wherein said computer is configured to provide an alarm when data communicated from said primary sensor to said computer indicates that the process parameter is outside of a predetermined range.

16. The system of claim 12 wherein said interface is a portable interface configured for portable use with said portable computer.

17. The system of claim 12 wherein said interface is configured to communicate identification data corresponding to said secondary sensor to the portable computer along with data corresponding to the process parameter.

18. The system of claim 12 wherein the process parameter corresponds to a temperature of a blood storage environment, and the primary sensor includes a primary temperature sensor coupled for communication of data corresponding to the temperature of the blood storage environment to said computer, and said secondary sensor includes a secondary temperature sensor configured to provide the secondary data to said portable computer.

19. A method of verifying a measurement of a process parameter, said method comprising the steps of:
measuring a process parameter with at least one sensor;
transmitting data corresponding to the measured process parameter to a computer via a coupling between the at least one sensor and the computer;
retrieving secondary data corresponding to the measured process parameter from the at least one sensor using an interface; and
transmitting the secondary data to the computer via a portable computer.

20. The method of claim 19 wherein said measuring step includes measuring the process parameter with a first sensor and a second sensor, the first sensor being coupled to the computer, said retrieving step including retrieving the secondary data from the second sensor.

21. The method of claim 19 wherein the process parameter is measured to be outside of a predetermined range during said measuring step.

22. The method of claim 21 further comprising the step of providing an alarm indicating that the process parameter is outside of the predetermined range.

23. The method of claim 22 further comprising the step of comparing the secondary data transmitted to the computer with the data corresponding to the measured process parameter to verify if the process parameter is outside of the predetermined range.

24. The method of claim 19 wherein said step of transmitting data includes transmitting identification data corresponding to the at least one sensor to the computer along with the data corresponding to the measured process parameter.

25. The method of claim 19 wherein said measuring step includes measuring a temperature of a blood storage environment with a primary temperature sensor and a secondary temperature sensor, said transmitting data step includes transmitting data corresponding to the measured temperature to the computer via a coupling between the primary temperature sensor and the computer, and said retrieving step includes retrieving secondary data corresponding to the measured temperature from the secondary temperature sensor using the interface.

26. A system for monitoring a temperature of a blood storage environment, said system comprising:
a computer configured to receive data corresponding to the temperature of the blood storage environment;
a primary temperature sensor configured to measure the temperature of the blood storage environment, said primary temperature sensor being coupled for communication of data corresponding to the temperature of the blood storage environment to said computer;
a secondary temperature sensor configured to measure the temperature of the blood storage environment;
an interface configured to receive secondary data corresponding to the temperature of the blood storage environment from said secondary temperature sensor; and
a portable computer configured to retrieve secondary data corresponding to the temperature of the blood storage environment from said interface, said portable computer being configured to transmit the secondary data to the computer to verify the measurement of said primary temperature sensor.
